(19) United States
(12) Patent Application Publication
(10) Pub. No.: US 2012/0211456 A1
(43) Pub. Date: Aug. 23, 2012

(54) Portable Hitch-mounted Hoist Device

(76) Inventor: Gang Wang, Shanghai (CN)

(21) Appl. No.: 13/052,102

(22) Filed: Mar. 20, 2011

(30) Foreign Application Priority Data
Feb. 17, 2011 (CN) 201110039307.9

(51) Int. Cl. B66C 23/44

(52) U.S. Cl. 212/180

(57) ABSTRACT

A portable hitch-mounted hoist device includes a lifting mechanism which applies a jack to supply power; a rotating mechanism having a dual bearing; a length-adjustable supporting mechanism; and a T-shaped mounting mechanism. The portable hitch-mounted hoist device has simple structure and is easy to install and detach.

### BACKGROUND OF THE PRESENT INVENTION

1. Field of Invention

The present invention relates to hoists and cranes, and more particularly to a portable hoist device which is mounted to a vehicle receiver.

2. Description of Related Arts

A hoist device for lifting a load or equipment into and out of a vehicle, such as a pickup truck, often is required since the load may not be lifted easily by hand. At present, the vehicle mainly used for transporting goods, almost has a standard vehicle receiver for being mounted a host device thereon. Various hoist or crane devices for use with a vehicle have been provided in the prior art, however, there are still some areas for improvement.

U.S. Pat. No. 7,607,546 to Hopper, issued Oct. 27, 2009, provides a hoist assembly which may be leveled horizontally and adjusted to a vertical position. Furthermore, the hoist assembly provides a load indicator to indicate a load exceeding the capacity of the hoist assembly, in order to ensure safe and proper lifting of the load.

However, the device of the Hopper is suit to lift the loads with a relatively lightweight. For the heavier loads, its original structure has to be modified so as to enhance lifting capacity. But then, the device of the Hopper would be ponderous and unportable.

Moreover, the device of Hopper applies a ram which is slantly located between a post and a boom to extend and force the boom to pivot upwards about the end of the post. Using a slant ram to provide a lifting force which is in a vertical position, the component force in a horizontal position generated by the slant ram is useless. Therefore, this unreasonable force distribution may not only waste energy, but also reduce the lifetime of the ram.

In U.S. Pat. No. 6,821,075, van der Horn also teaches a hoist adapted to fit with a standard vehicle receiver hitch with two structural supports extending from a boom support. The hoist of van der Horn can be collapsible for ease of storage. But it also has the force problem as Hopper's, and does not provide a flexible rotation mechanism. Furthermore, van der Horn does not provide a convenient and accurate means for positioning the hitch hoist.

A reasonable force design and flexible rotation mechanism are desirable to ensure proper operation of the device, especially under heavy loads. Furthermore, simple structure and easy operation are also desirable for a user.

### SUMMARY OF THE PRESENT INVENTION

An object of the present invention is to provide a portable hitch-mounted hoist device which has advantages of simple structure, easy installation, good stability, flexible rotation, and is able to be used for lifting heavy loads.

Another object of the present invention is to provide a portable hitch-mounted hoist device which applies a jack for supply lifting power, safe and laborsaving, only one person can complete whole operation.

Another object of the present invention is to provide a portable hitch-mounted hoist device which applies dual bearing to minimum the space between the rotating opponents, so as to make the rotation more flexible.

Another object of the present invention is to provide a portable hitch-mounted hoist device which has a simple supporting mechanism, wherein the height of the supporting mechanism is adjustable, so as to meet various requires of different vehicles.

Another object of the present invention is to provide a portable hitch-mounted hoist device which applies a T-shaped connector, which allows the relative position of the portable hitch-mounted hoist device is adjustable to the vehicle, fixable and convenient.

Another object of the present invention is to provide a portable hitch-mounted hoist device which applies a foldable structure, which makes storage and transport with the vehicle more easy and convenient.

Accordingly, in order to accomplish the above objects, the present invention provides a portable hitch-mounted hoist device, which comprises:

a lifting mechanism, which comprises a boom, a hook provided at a front end of the boom for attaching loads, a post having a top end pivotally connected to a rear end of the boom, and a jack having a top end pivotally connected to a middle portion of the boom and a bottom end connected to a bottom end of the post;

a rotating mechanism, which comprises a cylinder having a top portion connected to the lifting mechanism, a shaft rotatably sleeved in the cylinder, the shaft having a top end connected with the bottom end of the post, a ball bearing provided at the joint of the top end of the shaft and the bottom end of the post, and a tapered roller bearing provided at the bottom end of the shaft, so as to rotatably seat the shaft on the bottom portion of the cylinder;

a supporting mechanism, which comprises two length-adjustable outer supporting legs, each outer leg having a top end pivotally connected to the cylinder and a bottom end supporting on the ground, a middle supporting leg having a top end connected to the cylinder, two links, each link having one end pivotally connected to the corresponding outer supporting leg and the other end detachably connected to the bottom portion of the middle supporting leg; and

a mounting mechanism, which comprises a base beam having a first end fixed on the middle supporting leg and a second end inserted into a T-shaped connector, so that a inserted portion of the base beam is within the T-shaped connector, and the length of the inserted portion is adjustable, wherein the T-shaped connector comprises a beam collar matching with the second end of the base beam and a hitch tube matching with a standard vehicle receiver of a vehicle.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of according to the preferred embodiment of the present invention.

FIG. 2 is a schematic view of the lifting mechanism of the present invention.

FIG. 3 is a schematic view of the rotating mechanism of the present invention.

FIG. 4 is a schematic view of the supporting mechanism and the mounting mechanism of the present invention.

FIG. 5 is a schematic view of the portable hitch-mounted hoist device of the present invention in a folded position.

### DETAILED DESCRIPTION OF THE PREFERRED EMBODIMENT

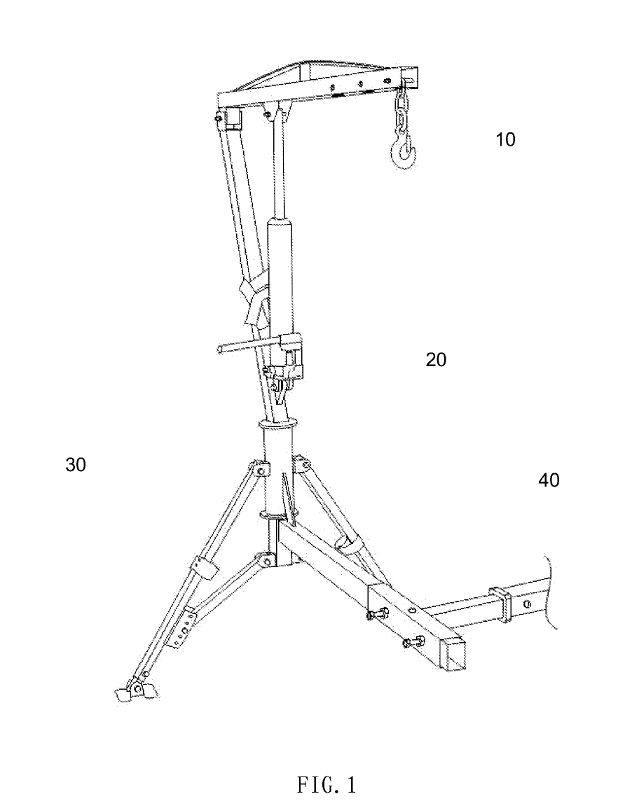

Various embodiments of the present invention will hereunder be described with reference to the accompanying drawings, from FIG. 1 to FIG. 5.

### First Embodiment

Referring to FIG. 1 of the drawings, a portable hitch-mounted hoist device according to a first embodiment of the present invention is illustrated, wherein the portable hitch-mounted hoist device comprises a lifting mechanism 10, a rotating mechanism 20, a supporting mechanism 30, and a mounting mechanism 40.

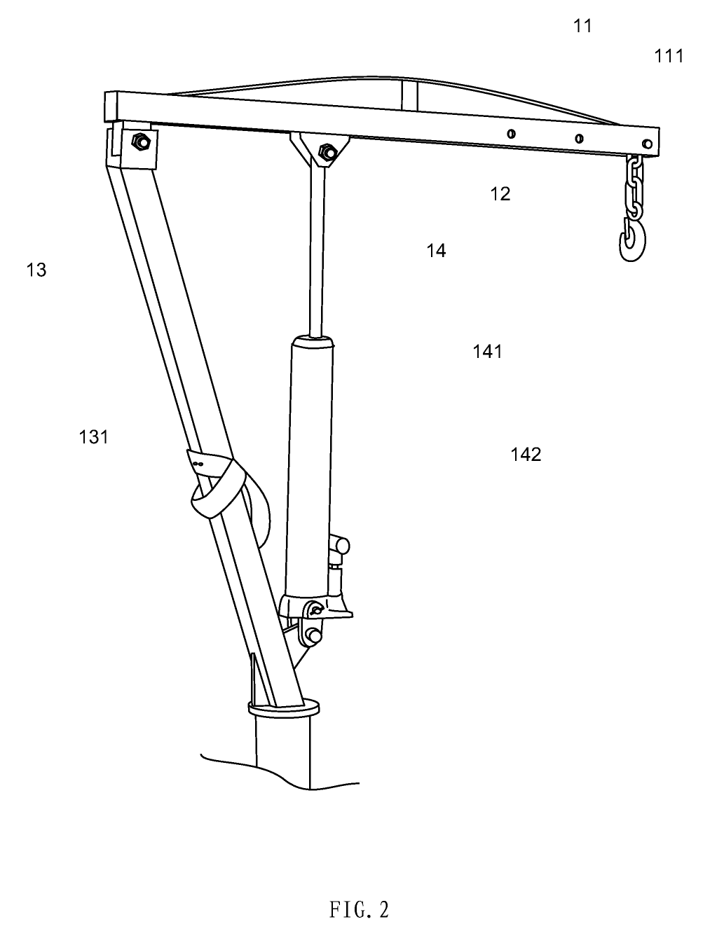

Referring to FIG. 2 of the drawings, the lifting mechanism 10 comprises a boom 11, a hook 12, a post 13, and a jack 14.

The hook 12 is provided at a front end of the boom 11 for attaching loads. The post 13 has a top end pivotally connected to a rear end of the boom 11. The jack 14 has a top end pivotally connected to a middle portion of the boom 11, and a bottom end connected to a bottom end of the post 13.

The boom 11 has a plurality of positions 111 aligned in the front portion of the boom 11. According to the different distances from the rear end of the boom 11, each position 111 has its own loading specification. When the portable hitch-mounted hoist device is at work, according to the weights of different loads, a user can choose the most suitable position 111 to install the hook 12. Concretely speaking, when lifting heavier loads, a position 111 at a distance closer to the rear end of the boom 11 should be chosen, on the contrary, when lifting lighter loads, a position 111 at a distance farther to the rear end of the boom 11 should be chosen. Here, according to the first preferred embodiment, the boom 11 has three positions 111.

Preferably, the jack 14 is a hydraulic jack, comprising a jack body 141 and a handle 142. One person can manually use the handle 142 to operate the jack 14, which is simple and convenient, does not require additional power.

The hydraulic jack has a compact structure and high transmission efficiency. It can lift heavy loads smoothly and is extremely well qualified for the working demand of the portable hitch-mounted hoist device.

According to the first preferred embodiment, the post 13 is in a lean-backward manner, which allows the jack 14 always keeping in the vertical position during work process. Meanwhile, the backward lean structure does not take lifting room and make the jack 14 always work in perfect situation. Therefore, this design can prolongs life time of the jack 14.

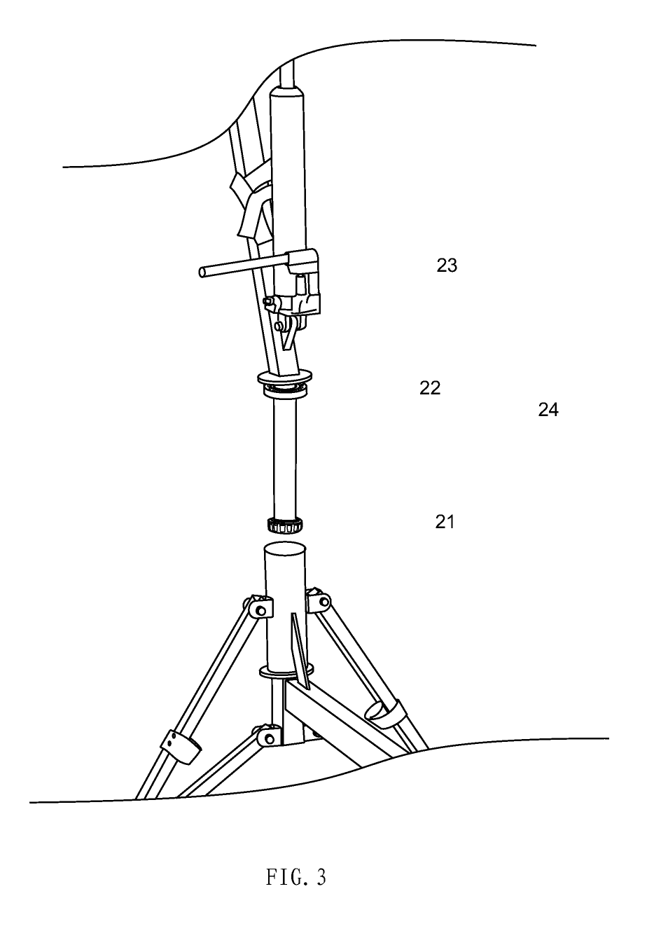

Referring to FIG. 3 of the drawings, the rotating mechanism 20 comprises a cylinder 21, a shaft 22, a ball bearing 23, and a tapered roller bearing 24.

The cylinder 21 has a top portion connected to the lifting mechanism 10, and a bottom portion fixed on the supporting mechanism 30. The shaft 22 is rotatably sleeved in the cylinder 21, and has a top end connected with the bottom end of the post 13. The ball bearing 23 is provided at the joint of the top end of the shaft 22 and the bottom end of the post 13. The tapered roller bearing 24 is provided at the bottom end of the shaft 22, so as to rotatably seat the shaft 22 on the bottom portion of the cylinder 21.

The lifting mechanism 10 belongs to a kind of cantilever beam structure. The load hanging on the rear end of the boom 11, is lifted under the action of the jack 14, and is moved in a horizontal position by the rotation of the post 13. As there is no counterweight in a symmetric position of the load to balance the load weight, a unilateral arm is generated. Therefore, in addition to the downward pressure generated by the load, a unilateral twisting force is also acted on the rotation mechanism. For the lifting mechanism 10 and the rotating mechanism 20 in the present invention, the side surface of the bottom end of the shaft 22 is tightly against the bottom portion of the cylinder 21 in a opposite direction of the load (radial force), and under the downward pressure generated by the load, the bottom surface of the shaft 22 presses on the bottom portion of the cylinder 21 (axial force), while the top end of the shaft 22 is tightly against the inside surface of the top portion of the cylinder 21 in the same direction of the load (radial force). Since the force of the shaft 22 generated in the bottom portion of the cylinder 21 is much larger than in the top portion of the cylinder 21, the rotating mechanism 20 is difficult to rotate the lifting mechanism 10. That is, if there is larger space between the shaft 22 and the cylinder 21, the portable hitch-mounted hoist device is not only unsafe, but also unrotated.

In the first embodiment, the cylinder 21 and the shaft 22 sleeved therewithin, and together with the ball bearing 23 and the tapered roller bearing 24 form a rotating mechanism. When the portable hitch-mounted hoist device is at work, the external cylinder 21 remains relatively stationary, but the internal shaft 22, under the dual bearing action of the ball bearing 23 and the tapered roller bearing 24, is rotated relatively to the cylinder 21, so as to cooperate with the post 13 which connected to the shaft 22 to achieve the purpose of rotating loads.

The ball bearing 23 is mainly used to bear radial force. In the present invention, it is set on the top end of the shaft 22 to balance radial force.

The tapered roller bearing 24 is adapted to bear both radial and axial force. In the present invention, it set on the bottom end of the shaft 22 to balance both radial and axial force.

The rotating mechanism 20 applies the dual bearing of the ball bearing 23 and the tapered roller bearing 24 to minimize the space between the cylinder 21 and the shaft 22, so as to overcome the problem of imbalance during lifting operation of the portable hitch-mounted hoist device. At the same time, the dual bearing design makes the rotating action flexible and rotating position easy to control, and ensures safe operation.

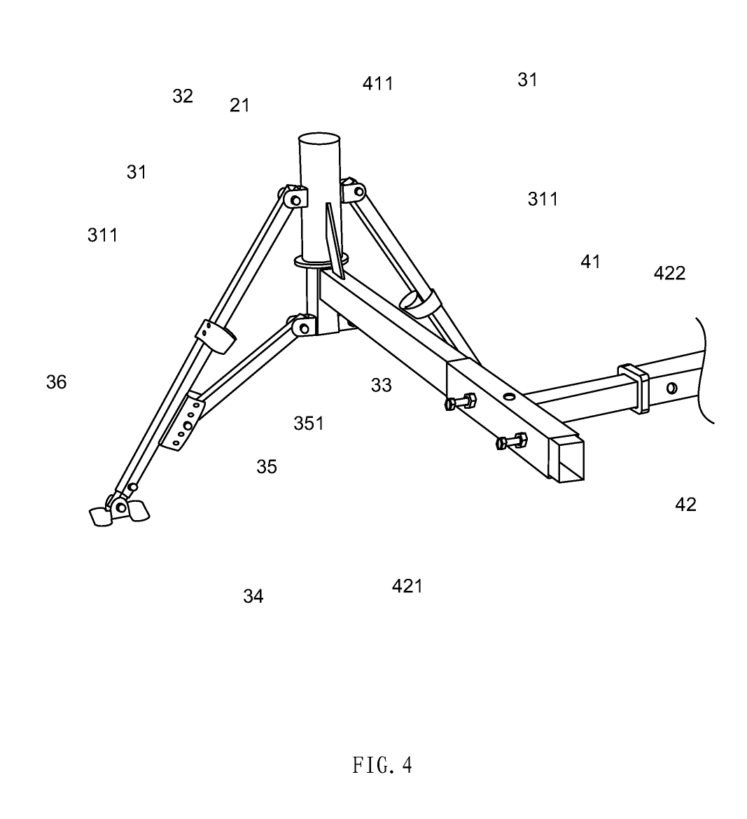

Referring to FIG. 4 of the drawings, the supporting mechanism 30 comprises two length-adjustable outer supporting legs 31, a middle supporting leg 32, and two links 33.

Each outer leg 31 has a top end pivotally connected to the cylinder 21, and a bottom end supporting on the ground. The middle supporting leg 32 has a top end connected to the cylinder 21. Each link 33 has one end pivotally connected to the corresponding outer supporting leg 31, and the other end detachably connected to the bottom portion of the middle supporting leg 32.

The two outer supporting legs 31, the two links 33 connected to the two outer supporting legs 31, and the middle supporting leg 32 form two triangle structures independently on both sides of the supporting leg 32. These triangle structures in the supporting mechanism 20 make the portable hitch-mounted hoist device more stable, and help to balance tilting during working, so as to keep the portable hitch-mounted hoist device from tilting.

As shown in FIG. 4, the mounting mechanism 40 comprises a base beam 41 and a T-shaped connector 42.

The base beam 41 has a first end fixed on the middle supporting leg 32 and a second end inserted into a T-shaped connector 42, so that a inserted portion of the base beam 41 is within the T-shaped connector 42, and the length of the inserted portion is adjustable. The T-shaped connector 42 comprises a beam collar 421 matching with the second end of the base beam 41 and a hitch tube 422 matching with a standard vehicle receiver of a vehicle.

The inserted portion of the base beam 41 is fixed on the beam collar 421 of the T-shaped connector 42 by screws or other easily removable hardware. Similarly, the hitch tube 422 is connected to the vehicle receiver, and also fixed by screws or other easily removable hardware.

It is worth to mention that since the T-shaped connector 42 applies T-shaped structure, so the length of the inserted portion of the base beam 41 is adjustable. That is, according to the different vehicles with different sizes, the portable hitch-mounted hoist device is able to adjust its optimal working position. It makes woke more convenient and flexible. When not in use, by adjusting the length of the inserted portion of the base beam 41, the portable hitch-mounted hoist device is able to move at a middle position of the vehicle, so as to ensure safe transport with the vehicle.

When at work, according to the height of the vehicle receiver, to adjust the angle between two outer supporting legs 31 and the lengths of two outer supporting legs 31, so as to adjust the portable hitch-mounted hoist device at a proper height.

Based on both weight and size of the loads, the user can select a most suitable position 111 to install the hook 12, and then operate the handle 142 to drive the jack 14 to work, and rotate the post 13 to achieve loading and unloading process.

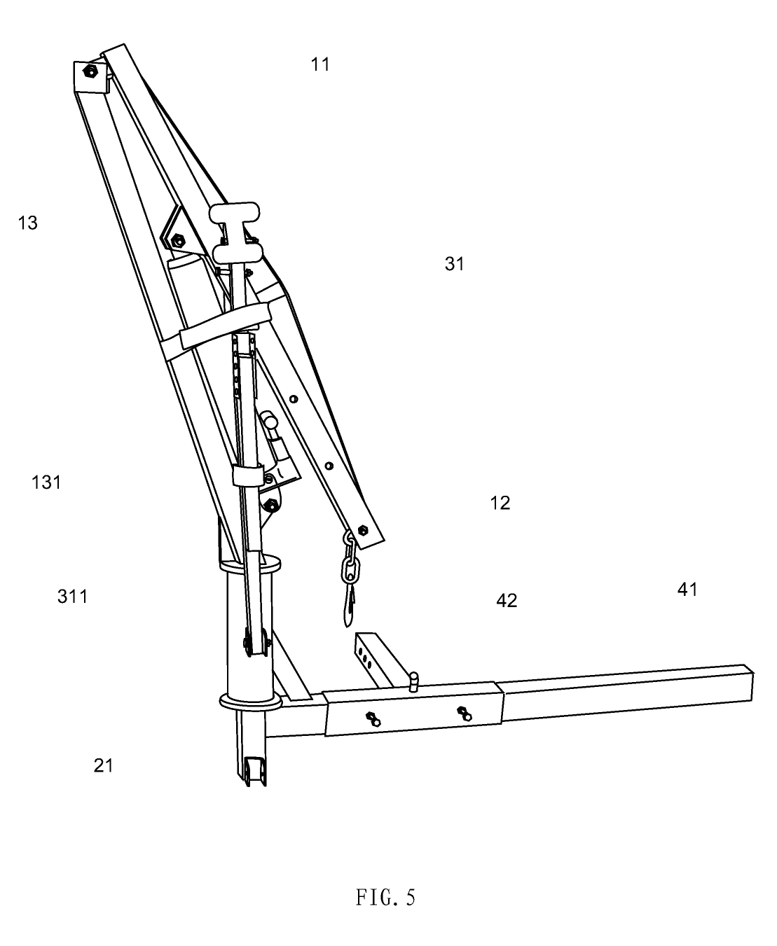

After work, the user can press down the front end of the boom 11 until the boom 11 parallels with the post 13, at this moment, the jack 14 is at a minimum length; then rotate the post 13 and the jack 14 to make them extremely on a uniform plane with the base beam 41; detach the one ends of two links 33 from the middle supporting leg 32, and then upturn the two outer supporting legs 31 together with the two links 33 connected thereto to a vertical position; adjust the length of the inserted portion of the base beam 41 to move the portable hitch-mounted hoist device at the middle position of the vehicle and fix it, so that the portable hitch-mounted hoist device is folded and fixed on the middle of the rear portion of the vehicle, which ensures convenient and safe transport together with the vehicle. As shown in FIG. 5.

Certainly, according to the user's preference or practical needs, after work, the user also can detach the T-shaped connector 42 from the vehicle receiver, so as to detach the portable hitch-mounted hoist device form the vehicle for separate storage and transport. When in use, the user only needs to install the-shaped connector 42 on the vehicle receiver. Since the hitch tube 422 of the T-shaped connector 42 and the vehicle receiver are fixed by screws or other easily removable hardware, it makes the detaching and installing process convenient and easy.

### Second Embodiment

The post 13 and the shaft 22 are fixed together by welding or other ways, and they are detachably connected to the cylinder 21 of the rotating mechanism 20, as shown in FIG. 3. Meanwhile, the two outer supporting legs 31 are detachably connected to the cylinder 21. The other features not described in this embodiment are substantially the same as those in the first embodiment.

After work, the user can press down the front end of the boom 11 until the boom 11 parallels with the post 13, at this moment, the jack 14 is at a minimum length; then detach the post 13 and the shaft 22 from the cylinder 21, detach the two outer supporting legs 31 from the cylinder 21, detach the two links 33 from the middle supporting leg 32, detach the base beam 41 from the T-shaped connector 42. That is, the portable hitch-mounted hoist device is detached into several parts in order to facilitate storage and transport.

### Third Embodiment

The jack 14 is an electrohydraulic jack. The other features not described in this embodiment are substantially the same as those in the first embodiment. Electric power is laborsaving, and it is supplied not only by external power, but also by batteries. Due to no external environmental limit, using batteries to supply power for the jack 14 is suitable for using in the wild or other occasions on which the external power is unavailable.

Alternatively, the jack 14 is able to be driven by mechanical power, or pneumatic power.

### Forth Embodiment

As shown in FIG. 4, the supporting mechanism 30 further comprises two feet 34 respectively provided at the bottom ends of two outer supporting legs 31. The feet 34 can be I-shaped, circular, square or other structures having a certain bearing area. The other features not described in this embodiment are substantially the same as those in the first embodiment.

### Fifth Embodiment

Each of the feet 34 is connected to a solid rod 36 respectively, wherein each of the solid rods 36 has a plurality of mounting positions thereon. Each solid rod 36 has a top portion which is inserted into the bottom end of the outer supporting leg 31, then the bottom end of the outer supporting leg 31 is fixed on one mounting position of the solid rod 36 by screw, so as to connect the foot 34 to the outer supporting leg 31. By adjusting the length of the top portion of the solid rod 36, that is, by mounting the bottom end of the outer supporting leg 31 on different mounting positions of the solid rod 36, the height of the portable hitch-mounted hoist device is adjusted. The other features not described in this embodiment are substantially the same as those in the forth embodiment.

### Sixth Embodiment

As shown in FIG. 4, the supporting portion further comprises two joint adjustments 35 respectively installed on two outer supporting legs 31, wherein each link 35 is adjustably and pivotally connected to its corresponding outer supporting leg 31 by one of the joint adjustment 35. Each joint adjustment 35 has a plurality of joint positions 351 thereon, wherein by installing the link 35 on the different joint positions 351, the angle between two outer supporting legs 31 is able to be adjusted, so that the height of the portable hitch-mounted hoist device is able to be adjusted for meeting various requires of different vehicles. The other features not described in this embodiment are substantially the same as those in the first embodiment.

### Seventh Embodiment

As shown in FIG. 2 and FIG. 5, the post 13 comprises a post band 131 provided at the middle portion thereof. After work, when the portable hitch-mounted hoist device is in a folded position, the post band 131 ties the post 13 to other components adjacent to the post 13 in order to keep a stable folded position for easy storage and transport with the vehicle. The other features not described in this embodiment are substantially the same as those in the first embodiment.

### Eighth Embodiment

As shown in FIG. 4 and FIG. 5, each outer supporting leg 31 comprises a band 311 provided at the middle portion thereof. After work, when the portable hitch-mounted hoist device is in a folded position, the band 311 ties the outer supporting leg 31 to other components adjacent to the outer supporting leg 31 in order to keep a stable folded position for easy placement and transport with the vehicle. The other features not described in this embodiment are substantially the same as those in the first embodiment.

### Ninth Embodiment

As shown in FIG. 4, the beam collar 421 of the T-shaped connector 42 has a plug hole thereon, wherein the base beam 41 has a corresponding hole thereon.

When not in use, by adjusting the length of the inserted portion of the base beam 41, the portable hitch-mounted hoist device is moved at the middle position of the vehicle. At this point, the plug hole in the beam collar 421 coincides with the corresponding hole in the base beam 41, then a plug is inserted into the plug hole and the corresponding hole to fix the beam collar 421 and the base beam 41 together. The other features not described in this embodiment are substantially the same as those in the first embodiment.

### Tenth Embodiment

When the other end of the base beam 41 is inserted into the beam collar 421 of the T-shaped connector 42, one or more hand wheels are used to make them fixed connection. Here, using hand wheel can eliminate the gap between the joint of the other end of the base beam 41 and the beam collar 421, so as to make the portable hitch-mounted hoist device more stable during work. The other features not described in this embodiment are substantially the same as those in the first embodiment.

### Eleventh Embodiment

As shown in FIG. 4, the base beam 41 is connected to the cylinder 21 by a reinforcing plate 411, which enhance connection strength between the base beam 41 and the other part of the portable hitch-mounted hoist device, so as to enhance the stability of the portable hitch-mounted hoist device. The other features not described in this embodiment are substantially the same as those in the first embodiment.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable hitch-mounted hoist device, comprising:
a lifting mechanism, which comprises a boom, a hook provided at a front end of the boom for attaching loads, a post having a top end pivotally connected to a rear end of the boom, and a jack having a top end pivotally connected to a middle portion of the boom and a bottom end connected to a bottom end of the post;
a rotating mechanism, which comprises a cylinder having a top portion connected to the lifting mechanism, a shaft rotatably sleeved in the cylinder, the shaft having a top end connected with the bottom end of the post, a ball bearing provided at the joint of the top end of the shaft and the bottom end of the post, and a tapered roller bearing provided at the bottom end of the shaft, so as to rotatably seat the shaft on the bottom portion of the cylinder;
a supporting mechanism, which comprises two length-adjustable outer supporting legs, each outer leg having a top end pivotally connected to the cylinder and a bottom end supporting on the ground, a middle supporting leg having a top end connected to the cylinder, two links, each link having one end pivotally connected to the corresponding outer supporting leg and the other end detachably connected to the bottom portion of the middle supporting leg; and
a mounting mechanism, which comprises a base beam having a first end fixed on the middle supporting leg and a second end inserted into a T-shaped connector, so that a inserted portion of the base beam is within the T-shaped connector, and the length of the inserted portion is adjustable, wherein the T-shaped connector comprises a beam collar matching with the second end of the base beam and a hitch tube matching with a standard vehicle receiver of a vehicle.

2. The portable hitch-mounted hoist device, as recited in claim 1, wherein the post and the shaft are fixed together, and the post and the shaft are detachably connected to the cylinder of the rotating mechanism; wherein the two outer supporting legs are detachably connected to the cylinder.

3. The portable hitch-mounted hoist device, as recited in claim 1, wherein the boom has a plurality of positions aligned in the front portion of the boom.

4. The portable hitch-mounted hoist device, as recited in claim 3, wherein the post is in a lean-backward manner.

5. The portable hitch-mounted hoist device, as recited in claim 4, wherein the supporting mechanism further comprises two feet respectively provided at the bottom ends of two outer supporting legs.

6. The portable hitch-mounted hoist device, as recited in claim 5, wherein each of the feet is connected to a solid rod respectively, wherein each solid rod has a plurality of mounting position thereon and has a top portion inserted into the bottom end of the outer supporting leg, wherein by mounting the bottom end of the outer supporting leg on different mounting positions, the length of the top portion of the solid rod is adjusted, so that the height of the portable hitch-mounted hoist device is adjustable.

7. The portable hitch-mounted hoist device, as recited in claim 6, wherein the supporting mechanism further comprises two joint adjustments respectively installed on two outer supporting legs, wherein each link is adjustably and pivotally connected to its corresponding outer supporting leg by one of the joint adjustments, wherein each joint adjustment has a plurality of joint positions thereon, and by installing the link on the different joint positions, the angle between two outer supporting legs is able to be adjusted, so as to adjust the height of the portable hitch-mounted hoist device.

8. The portable hitch-mounted hoist device, as recited in claim 7, wherein the post comprises a post band provided at the middle portion thereof, and each outer supporting leg comprises a band provided at the middle portion thereof.

9. The portable hitch-mounted hoist device, as recited in claim 8, wherein the beam collar of the T-shaped connector has a plug hole thereon, and the base beam has a corresponding hole thereon, wherein when the portable hitch-mounted hoist device is moved at the middle position of the vehicle, the plug hole in the beam collar coincides with the corresponding hole in the base beam, and a plug is inserted into the plug hole and the corresponding hole to fix the beam collar and the base beam together.

10. The portable hitch-mounted hoist device, as recited in claim 9, wherein the jack is able to be driven by hydraulic power, mechanical power, or pneumatic power.

11. The portable hitch-mounted hoist device, as recited in claim 10, wherein when the base beam is inserted into the beam collar of the T-shaped connector, use one or more hand wheels to fix the base beam and the beam collar together.

12. The portable hitch-mounted hoist device, as recited in claim 2, wherein the boom has a plurality of positions aligned in the front portion of the boom.

13. The portable hitch-mounted hoist device, as recited in claim 12, wherein the post is in a lean-backward manner.

14. The portable hitch-mounted hoist device, as recited in claim 13, wherein the supporting mechanism further comprises two feet respectively provided at the bottom ends of two outer supporting legs.

15. The portable hitch-mounted hoist device, as recited in claim 14, wherein each of the feet is connected to a solid rod respectively, wherein each solid rod has a plurality of mounting position thereon and has a top portion inserted into the bottom end of the outer supporting leg, wherein by mounting the bottom end of the outer supporting leg on different mounting positions, the length of the top portion of the solid rod is adjusted, so that the height of the portable hitch-mounted hoist device is adjustable.

16. The portable hitch-mounted hoist device, as recited in claim 15, wherein the supporting mechanism further comprises two joint adjustments respectively installed on two outer supporting legs, wherein each link is adjustably and pivotally connected to its corresponding outer supporting leg by one of the joint adjustments, wherein each joint adjustment has a plurality of joint positions thereon, and by installing the link on the different joint positions, the angle between two outer supporting legs is able to be adjusted, so as to adjust the height of the portable hitch-mounted hoist device.

17. The portable hitch-mounted hoist device, as recited in claim 16, wherein the post comprises a post band provided at the middle portion thereof, and each outer supporting leg comprises a band provided at the middle portion thereof.

18. The portable hitch-mounted hoist device, as recited in claim 17, wherein the beam collar of the T-shaped connector has a plug hole thereon, and the base beam has a corresponding hole thereon, wherein when the portable hitch-mounted hoist device is moved at the middle position of the vehicle, the plug hole in the beam collar coincides with the corresponding hole in the base beam, and a plug is inserted into the plug hole and the corresponding hole to fix the beam collar and the base beam together.

19. The portable hitch-mounted hoist device, as recited in claim 18, wherein the jack is able to be driven by hydraulic power, mechanical power, or pneumatic power.

20. The portable hitch-mounted hoist device, as recited in claim 19, wherein when the base beam is inserted into the beam collar of the T-shaped connector, use one or more hand wheels to fix the base beam and the beam collar together.
